(19) United States
(12) Patent Application Publication
(10) Pub. No.: US 2016/0357498 A1
(43) Pub. Date: Dec. 8, 2016

(54) Gamified Adaptive Digital Disc Jockey

(71) Applicant: Microsoft Technology Licensing, LLC, Redmond, WA (US)

(72) Inventor: Georgios Krasadakis, Dublin (IE)

(21) Appl. No.: 14/729,125

(22) Filed: Jun. 3, 2015

(51) Int. Cl. G06F 3/16; G07F 17/32

(52) U.S. Cl. CPC G06F 3/16; G07F 17/3227; G07F 17/3206; G07F 17/323; G07F 17/3244

(57) ABSTRACT

Example apparatus and methods provide a gamified adaptive digital disc jockey (DDJ) that optimizes a media presentation based on an audience response according to a gamification process. The DDJ receives data about audience members and determines a state and dynamic of the audience in response to a portion of the media presentation or the dynamics of the media presentation. The DDJ identifies audience leaders or laggards from gamification data or patterns about audience members. The gamification scores may be computed from the reactions or behaviors of audience members. The DDJ automatically adapts the media presentation based on the state and dynamic of the audience in general and/or based on the reactions of people with certain gamification scores. Data relating states, dynamics, gamification scores, and tracks or sequences of tracks from previous presentations may help plan and optimize the presentation and may be stored for planning future presentations.

### BACKGROUND

Human disc jockeys monitor the reaction of an audience to a track being played in a mix. Some disc jockeys may amend a track or mix based on audience reaction while other disc jockeys may stick to their pre-planned mix regardless of audience reaction. Human disc jockeys can observe how many people are dancing and how energetically they are dancing. Human disc jockeys can also see how many people are standing around, how many people are sitting, how many people appear to be talking in small groups, and whether a track brought people onto the dance floor or drove them back into their seats. Human disc jockeys can hear whether people cheer or boo when a track starts. Human disc jockeys can choose to take requests and can even introduce a requested track by introducing or talking over the music. Some human disc jockeys may try to establish a certain mood for an event. For example, a disc jockey may try to produce one energy level and mood for a teen dance party and may try to produce another energy level or mood for a 50^{th} wedding anniversary for two senior citizens. However, human disc jockeys tend to operate under a simple guiding principle that people should be dancing at a dance party and that the disc jockey knows best. Many disc jockeys feel the need to be part of the show.

Digital disc jockeys have been produced that attempt to mimic some of the actions performed by a human disc jockey. Like human disc jockeys, digital disc jockeys may operate one hundred percent of the time under a single guiding principle that people should be dancing. Although they don't have eyes and ears, digital disc jockeys may receive inputs from video cameras, microphones, pressure sensors in a dance floor, and other environmental sensors. These inputs may help the digital disc jockey determine how many people are dancing and their overall energy level. Digital disc jockeys may also collect information from sensors (e.g., accelerometer in smart phone) carried by members of the audience. These inputs may also help determine how many people are dancing and their energy level. Digital disc jockeys may try to determine whether the audience likes a track based on the inputs from the sensors and may alter the track or mix based on the determination. If the audience likes the track, then the digital disc jockey may let the track play to completion and may select future tracks in the mix based on this track. If the audience doesn't like the track, then the digital disc jockey may fade the track out early and may remove or diminish other similar tracks from the mix.

Both human and digital disc jockeys tend to evaluate individual tracks and plan a mix based on the instantaneous reaction of an audience. Disc jockeys may make mental notes based on their interpretation of how much the audience liked a track. This information tends to be event specific or track specific. Both human and digital disc jockeys tend to analyze an audience as a whole and consider all members of the audience as fungible. Thus, determinations about whether the audience liked a track may be based on averages or overall impressions.

Parties are interesting events for which attendees may want mementos. Party attendees may like receiving photographs or videos from the party. Before the advent of ubiquitous cameras in smart phones, some party organizers or disc jockeys would employ photographers to take pictures to record the event. While there may have been some verbal coordination between a disc jockey and a photographer, the coordination may have been tenuous at best due to the attention demands on the disc jockey. Digital disc jockeys may also have cameras available for taking photographs or videos. A digital disc jockey may be programmed to take photos or videos at certain intervals, at certain specific times, or in other ways (e.g., randomly). Both human and digital photographers may try to get pictures of specific people (e.g., the bride at a wedding). These photography assignments may have been pre-planned (e.g., take a photograph of the bride when a certain track is played). However, as disc jockeys amend a mix, the track for which the photograph was planned may never be played. Additionally, as the event proceeds, the target may be out of the frame or room when the track is played. Thus, the planning and execution of photographic opportunities may have been difficult to coordinate with disc jockeys.

### SUMMARY

This Summary is provided to introduce, in a simplified form, a selection of concepts that are further described below in the Detailed Description. This Summary is not intended to identify key features or essential features of the claimed subject matter, nor is it intended to be used to limit the scope of the claimed subject matter.

Example apparatus and methods concern a gamified digital disc jockey (DDJ). A DDJ may adapt to audience preferences in real-time as controlled, at least in part, by gamification logic and related feedback loops. Like conventional systems, a DDJ may receive real-time feedback from sensors (e.g., cameras, microphones, accelerometers) positioned at a venue or carried by attendees and make determinations about a track or mix or the event itself, based on the feedback. The sensors may be hardware sensors or software sensors. Unlike conventional systems, the DDJ may perform actions like identifying party leaders or dance leaders and basing track and mix decisions on the reactions of specific individuals rather than on an audience as a whole. In one embodiment, the DDJ may base track and/or mix decisions on a combination of feedback from the audience as a whole and key members of the audience. A DDJ may consider gamification patterns that facilitate identifying significant audience members (e.g., most socially relevant attendee) and weighting their reactions to a track more heavily than less socially relevant attendees. While instantaneous scores may be employed, the DDJ may also track the behavior/scores/attitude of significant audience members over time, across the event, and/or in comparison with other significant audience members. Thus, rather than just responding to instantaneous scores, the DDJ may respond to the dynamics of responses. Like conventional systems, a DDJ may receive requests and may add them to a viewable list of what tracks are going to play next. Unlike conventional systems, a DDJ may consider gamification patterns that allow audience members to pick or pan a specific track request so that it will be added to the mix earlier or removed. Gamification patterns may also be used to rank the value of a requestor. For example, a person dancing with the widest variety of people may get preference for a request.

Like conventional disc jockeys, a DDJ may seek to establish a certain mood. Unlike conventional disc jockeys, a DDJ may have a party timeline that establishes a path and trajectory for the mood at different points in a party. For example, a party organizer may want lulls in the dance action to provide opportunities to market goods or services, to provide opportunities for attendees to purchase tracks, to provide opportunities for attendees to post to social media, to provide opportunities for wait staff to take a break, to clear dishes, or to provide refreshments, or for other activities. An example DDJ may therefore select tracks in sequences for the mix that will produce peaks and valleys in dance energy and dancer volume (e.g., number of people dancing). Additionally, the party timeline may be crafted for different demographics at different times. For example, a mix may be crafted so that a first demographic will dance followed by a second demographic. While one demographic is dancing the other demographic may have opportunities for other interactions and vice versa. Since a DDJ may want to follow a party timeline, tracks may be selected based on their interactions with other tracks. Thus, unlike conventional systems where a track may be viewed in isolation, an example DDJ may determine not just the effect a track has in isolation, but also the effect the track has on subsequent tracks and how a track was affected by previous tracks. Information about track sequences and their effect on dance energy trajectory may be stored for use in subsequent events.

Like conventional disc jockeys, a DDJ may have cameras and other recording equipment available to record a portion of an event. Unlike conventional disc jockeys, a DDJ may consider gamification patterns that facilitate identifying significant audience members (e.g., most socially relevant attendee) and acquiring photos, videos, sound recordings, or other recordings of the actions and interactions of these specific audience members at certain important moments. An example DDJ can capture these moments and associate them with the party timeline and specific track being played at that moment. Photos or videos may be presented back to the audience during the event as part of the gamification process (e.g., person dancing the most gets their picture displayed). For example, the picture may be displayed publicly with a caption (e.g., a few minutes ago).

Example apparatus and methods may employ facial recognition to further enhance the experience produced by a DDJ. A conventional disc jockey may focus on one individual (e.g., the bride at a wedding) and try to pick tracks that make the bride smile. A DDJ may identify as many faces as possible in the audience and may then try to produce a mix that gets a threshold number of identified faces to react in a certain positive manner. For example, the DDJ may try to get a certain percentage of faces to smile at least once within a certain time frame. Facial recognition may also be used for a finer grained evaluation of a track. For example, overall statistics for audience response may indicate that half of the attendees liked two tracks. However, facial recognition may facilitate determining that the people who liked a first track were in a first demographic (e.g., seniors) while the people who liked a second track were in a second demographic (e.g., teens). In one embodiment, the facial analysis may produce metadata about audience members. Conventional systems may have rated the tracks equally, while example systems would note the different reactions.

### BRIEF DESCRIPTION OF THE DRAWINGS

The accompanying drawings illustrate various example apparatus, methods, and other embodiments described herein. It will be appreciated that the illustrated element boundaries (e.g., boxes, groups of boxes, or other shapes) in the figures represent one example of the boundaries. In some examples, one element may be designed as multiple elements or multiple elements may be designed as one element. In some examples, an element shown as an internal component of another element may be implemented as an external component and vice versa. Furthermore, elements may not be drawn to scale.

FIG. 1 illustrates an example gamified adaptive digital disc jockey.

FIG. 2 illustrates an example gamified adaptive digital disc jockey.

FIG. 3 illustrates an example method associated with an example gamified adaptive digital disc jockey.

FIG. 4 illustrates an example method associated with an example gamified adaptive digital disc jockey.

FIG. 5 illustrates an example apparatus performing as an example gamified adaptive digital disc jockey.

FIG. 6 illustrates an example apparatus performing as an example gamified adaptive digital disc jockey.

FIG. 7 illustrates an example cloud operating environment in which an example system or method may operate.

FIG. 8 is a system diagram depicting an exemplary mobile communication device that may act as a gamified adaptive digital disc jockey.

FIG. 9 illustrates an example game console programmed to operate as an example gamified adaptive digital disc jockey.

### DETAILED DESCRIPTION

Example apparatus and methods concern a gamified adaptive digital disc jockey (DDJ). A DDJ may adapt to audience preferences in real-time based, at least in part, on gamification information and reasoning. A DDJ may receive real-time feedback from sensors (e.g., cameras, microphones, accelerometers) positioned at a venue and/or carried by attendees. A DDJ may make determinations about a track or mix based on the implicit and/or explicit feedback. A DDJ may perform actions like identifying party leaders or dance leaders and basing track and mix decisions on the reactions of specific individuals and not only on an audience as a whole. A DDJ may consider gamification patterns that facilitate identifying significant audience members (e.g., most socially relevant attendee, person dancing the most/best) and weighting their reactions to a track or series of tracks more heavily than less socially relevant attendees. A DDJ may receive requests and may add them to a viewable list of tracks that are going to play next. A DDJ may consider gamification patterns that allow audience members to pick or pan a specific track request so that it will be added to the mix earlier, removed, or even repeated. Gamification patterns may also be used to rank the value of a requestor. For example, a person dancing with the most different people may get preference for a request.

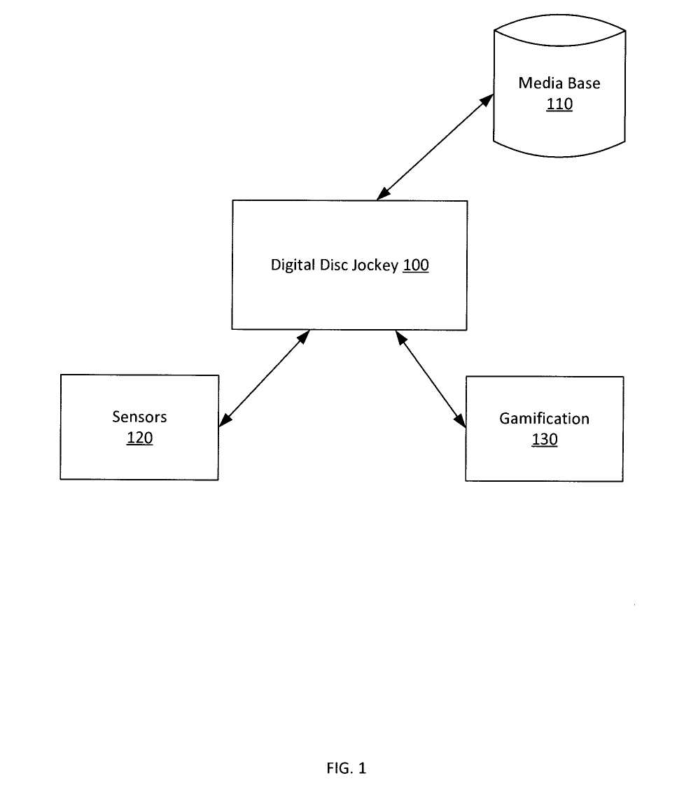

FIG. 1 illustrates an example gamified DDJ 100. The DDJ 100 has access to a data store 110 in which tracks and data about tracks is stored. The data store 110 may be referred to as a media base. In one embodiment tracks may also be available from a streaming media service 150. The data about the tracks may include typical metadata like play time, beat rate, name, artist, and other information. The data about the tracks may also include additional data including, for example, state data, dynamic data, sequence data, and candidate mixes for an event type. The candidate mixes may be crafted for a certain culture and time moment. The metadata may also include, for example, information about genre, classification, associated mood, popularity, trend, performance in similar events, performance in typical events, demographic targeting, life-style classification, predicted performance, predicted performance dynamics, seasonality tags, occasion tags, and typical associated social profiles. The DDJ 100 receives information about audience reaction to a track from sensors 120. The sensors 120 may include sensors associated with the space in which the tracks are being played. For example, cameras, microphones, floor pressure sensors, and other devices may provide information about what is going on in a space. The sensors 120 may also include sensors associated with the people in the space. For example, smartphones, wearables such as smart watch, glasses and other personal electronics carried by people in the space may provide information from accelerometers and other parts of the smartphones.

The DDJ 100 receives the sensor information and, unlike conventional systems, employs a gamification apparatus 130 or service to apply gamification reasoning, analysis, or processes to the behavior, performance, and/or feedback of people at the event. Gamification refers to the use of game thinking and game mechanics in non-game contexts. Gamification may be used to enhance engagement of people with an application or apparatus. Thus, while a dance party may not be a game, treating people at the dance party like game contestants may produce a more optimal individual and group experience. Gamification may employ an empathy-based approach for introducing, transforming, or operating a service system that lets people have a gameful experience. Gamification may leverage people's natural desires for socializing, mastery, competition, achievement, status, self-expression, or other attributes. At a typical dance, a person may be on the cusp of asking someone to dance but just can't bring themselves to do it. Treating attendees like contestants may provide the final impetus to get someone to dance who otherwise wouldn't. For example, a person may get up and dance to collect enough points. The person may see a public display in the event space show their scores improving in terms of energy or activity levels. A special case or target of the gamification process concerns the organizer of the event. For example, the organizer may want the event to be a success and to have an overall positive feedback from the audience. An example gamification process may cause the organizer to compete with similar in-context events to achieve a higher score that will be an indication of success. For example, within a school for a specific year, parties could be listed in a comparative way in terms of success and audience excitement. The scores may then be reported through, for example, connected social accounts, closed groups, web applications, mobile applications or as other parts or extensions of the DDJ . For example, a certain party may be identified as being within the top 5% of birthday parties in the area with respect to fun and energy.

Gamification may include rewarding certain people based on achievements. In a dance party environment where a digital disc jockey is present, attendees may have a gameful experience with respect to dancing and socializing. For example, behavior of an attendee may be monitored, rewarded, or incentivized. Behavior including, for example, how much they are dancing, how well they are dancing, how appropriately they are dancing, how the audience is reacting as evidenced by their dancing, how much they are socializing, the ways in which they are socializing (e.g., within demographic, outside demographic), the ways in which people are interacting with them, and other behavior may be monitored. Rewards may include, for example, recognition on a video display board, the ability to request a track, receiving a physical token (e.g., hat, badge, bracelet), receiving a virtual token (e.g., points in a store), or other responses.

Based on the data from the sensors 120 and the gamification apparatus 130, the DDJ 100 may change a track or direction/strategy within the mix. While conventional systems may also change a track or mix, DDJ 100 takes the additional action of basing its decision on the gamification process and feedback data and on sequences of tracks rather than just individual tracks. While a single track may produce a single reaction, a sequence of tracks may produce a reaction that is greater than the sum of its parts. In one embodiment, a DDJ executes a strategy of continuous optimization of audience experiences.

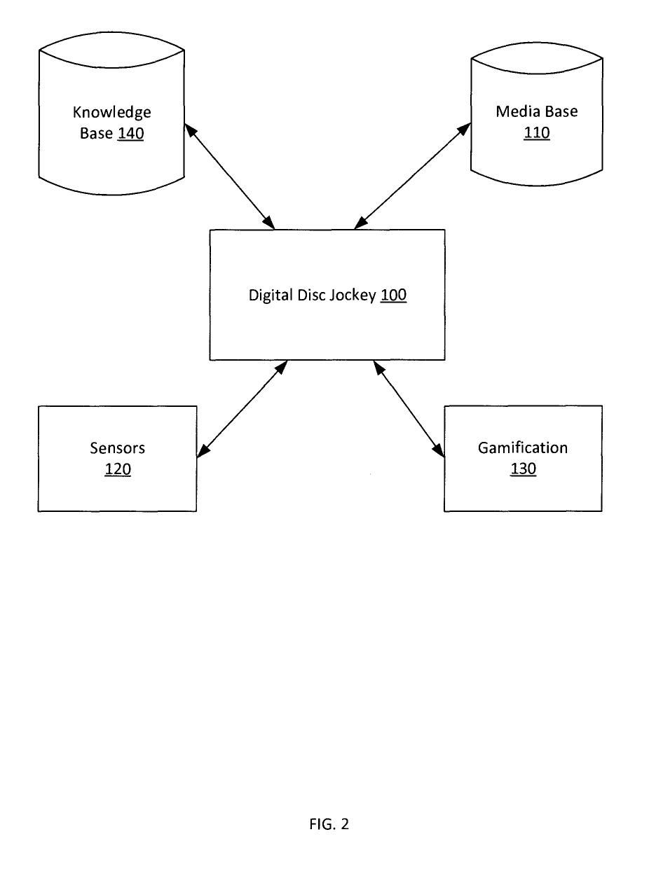

FIG. 2 illustrates another embodiment of DDJ 100 that accesses a knowledge base 140. Knowledge base 140 may store data concerning previous presentations of tracks and mixes. In one embodiment, the knowledge base 140 may store a history of tracks within a specific event. The data may store information about the state associated with a track during a presentation and about a dynamic associated with a track during a presentation. The state may record what was happening at a single point in time while the dynamic may record how the state was changing over time. Thus, unlike conventional systems that may record information about a single track and the reaction to the track, DDJ 100 may have access to information about a track in the context of a mix. In one embodiment, DDJ 100 may have access to information about the track in the context of the event type, the specific occasion, the market, the language, the culture, or other attributes. In one embodiment, the DDJ 100 may have access to information about a track or mix in the context of a class of event. The class may identify, for example, different time frames and cultures. DDJ 100 may access knowledge base 140 to acquire information that facilitates planning a mix. In one embodiment, planning the mix may include making out-of-mix picks in real time. DDJ 100 may also update knowledge base 140 with information about tracks that it plays and mixes that it plays. In one embodiment, the DDJ 100 may use prior knowledge and trends to facilitate optimizing the audience experience and achieving certain gamification goals. For example, DDJ 100 may have information about the expected songs to be played for this type of event for this market for this season. For example, in summer, the DDJ 100 may suitably enrich the mix with expected seasonal, summer songs. In one embodiment, DDJ 100 may have information about what is trending (e.g., moving up fast). Information about what is trending may be combined with information about the specific type of event, culture/market, timing, and other factors to update the mix. In one embodiment, the DDJ 100 may have information about the organizer of the event and may even have information about certain specific people who are expected to be members of the audience. For example, knowledge base 140 may have information about a set of parties organized by students of a certain school. Information about song preferences, reactions, and gamification data may therefore be available to DDJ 100. In this scenario, a person who has been identified previously as a leader across events may receive increased significance. Information in knowledge base 140 may allow DDJ 100 to compare events at the same school within a period (e.g., school year, season) and extend the gamification analysis to consider the highest ranked parties of the year, the highest ranked moments, the highest ranked dancers and other factors to plan or update the mix,

Example apparatus and methods may blend sample periods and performance periods in a mix. During a sample period, a DDJ may cycle through a set of tracks that are being considered for extended play in the mix in this event or in other events. Short samples (e.g., 15 seconds) of the tracks under consideration may be played. The duration of the short samples may be based on information about previous presentations of the sample or song associated with the sample. Audience reaction and relevant individual reactions including effects on gamification scores may be monitored to help determine tracks for the upcoming mix. In one embodiment, a digital disc jockey will not amend a track during a sample period. A sample period may be followed by a performance period where the disc jockey may amend tracks and the mix based, at least in part, on information about tracks that were evaluated during the sample period.

Human disc jockeys and digital disc jockeys sometimes face conflicting goals with respect to organizer preferences, audience requests, and party energy. For example, a disc jockey may predict that certain requests will negatively impact dance energy or dance volume. A DDJ may be able to resolve apparently conflicting goals by analyzing the organizer preferences or audience requests during a sample period and producing a mix that will both produce an acceptable energy level for the party while complying with the wishes of the party organizer and attendees—thus balancing the conflicting goals. For example, the organizer may have identified ten tracks that they wanted played. Portions of the ten tracks may be presented during a sample period and different orders for presenting the ten tracks may be evaluated. Similar or complementary tracks may be identified during the sample period. Then, during the performance period, the organizer will be happy to see a party with good energy while hearing at least a portion of some of their selected tracks. Also, the disc jockey may have sample data to support a decision to play or not play a particular request or organizer preference.

A certain well-known track may have the potential to produce a high dance energy at a party, but only if people are already dancing. Thus, a sequence of tracks may be planned that will maximize the number of people already dancing before the well-known track is played by preparing the audience for the significant target song. The sequence information may be stored for subsequent events. Similarly, another well-known track may have the potential to produce a group experience (e.g., coordinated community dance) but only if a certain blend of people are already dancing. Thus, a sequence of tracks may be planned that will increase the likelihood that an appropriate mix of people are on the dance floor when the group experience track is played. The group experience or high energy dance can be used as crescendos or high points along a party time line. Following the build up and the crescendo itself, opportunities may exist in the party timeline for other activities that benefit from a lull in the action (e.g., push notification for marketing, sending wait staff out with refreshments).

In one embodiment, a party timeline may include information concerning the structure of an event (e.g., phases), duration, expected audience behavior, or other attributes. The party timeline may be set up by an event organizer and provided as hints or guidelines for the DDJ. In one embodiment, a party timeline may be deduced from knowledge accumulated for other similar events having similar audience demographics or other similar attributes. The party timeline may be adjusted in real time based on the inputs and feedbacks. In one embodiment, an event organizer may configure the party timeline to have a desired duration (e.g., four hours), certain goals in terms of audience participation and energy levels and specific peak moments. In one embodiment, an event organizer may configure the party timeline to have a fixed song (e.g., happy birthday). In one embodiment, an event organizer may configure the party timeline to have a break at a specific time (e.g., midnight, twenty minutes before party is supposed to conclude).

Some portions of the detailed descriptions that follow are presented in terms of algorithms and symbolic representations of operations on data bits within a memory. These algorithmic descriptions and representations are used by those skilled in the art to convey the substance of their work to others. An algorithm is considered to be a sequence of operations that produce a result. The operations may include creating and manipulating physical quantities that may take the form of electronic values. Creating or manipulating a physical quantity in the form of an electronic value produces a concrete, tangible, useful, real-world result.

It has proven convenient at times, principally for reasons of common usage, to refer to these signals as bits, values, elements, symbols, characters, terms, numbers, distributions, and other terms. It should be borne in mind, however, that these and similar terms are to be associated with the appropriate physical quantities and are merely convenient labels applied to these quantities. Unless specifically stated otherwise, it is appreciated that throughout the description, terms including processing, computing, and determining, refer to actions and processes of a computer system, logic, processor, system-on-a-chip (SoC), or similar electronic device that manipulates and transforms data represented as physical quantities (e.g., electronic values).

Example methods may be better appreciated with reference to flow diagrams. For simplicity, the illustrated methodologies are shown and described as a series of blocks. However, the methodologies may not be limited by the order of the blocks because, in some embodiments, the blocks may occur in different orders than shown and described. Moreover, fewer than all the illustrated blocks may be required to implement an example methodology. Blocks may be combined or separated into multiple components. Furthermore, additional or alternative methodologies can employ additional, not illustrated blocks.

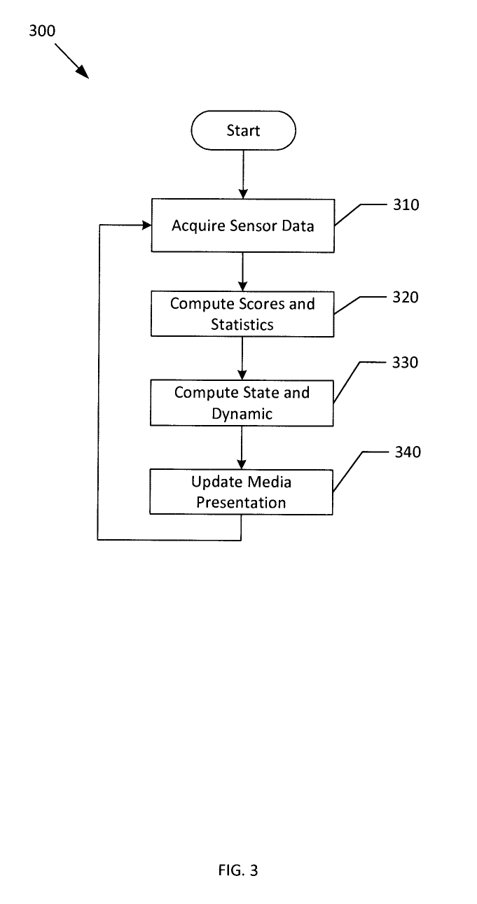

FIG. 3 illustrates a computerized method 300 associated with a gamified adaptive digital disc jockey. Method 300 may automatically update a media presentation being presented to an audience by the gamified adaptive digital disc jockey in response to a state of the audience and certain dynamics of the audience. Method 300 includes, at 310, acquiring sensor data from which the state and dynamic may be computed. The sensor data may also be used for gamification purposes. Thus, method 300 proceeds, at 320, to compute scores or statistics that may be used in gamification analysis (e.g., identifying behavioral patterns) of members of the audience to which the media presentation is being made.

Method 300 then proceeds, at 330, to derive the state of the audience and the dynamic of the audience. Unlike conventional systems, the state of the audience and the dynamic of the audience may be expressed in terms of gamification scores associated with members of the audience. The gamification patterns may identify leaders in categories including, for example, social interactions, dancing, singing along, or other activities. Singing along may be identified using, for example, sound information provided by sound equipment and lip reading information provided by facial recognition equipment. An approval level for a track may depend, at least in part, on how many people are singing along.

Method 300 then proceeds, at 340, to update the media presentation based on a state of the audience and a dynamic of the audience. In one embodiment, the media presentation is updated to increase a likelihood that a subsequent state of the audience will approach a desired state of the audience at a selected point in time. In one embodiment, the media presentation is updated to increase a likelihood that a subsequent dynamic of the audience will approach a desired dynamic of the audience at the selected point in time. Thus, unlike conventional systems that may update a track or mix based solely on a snapshot reaction to a track, method 300 may amend a track or a mix based on richer data associated with the changes in state, dynamic, or gamification scores.

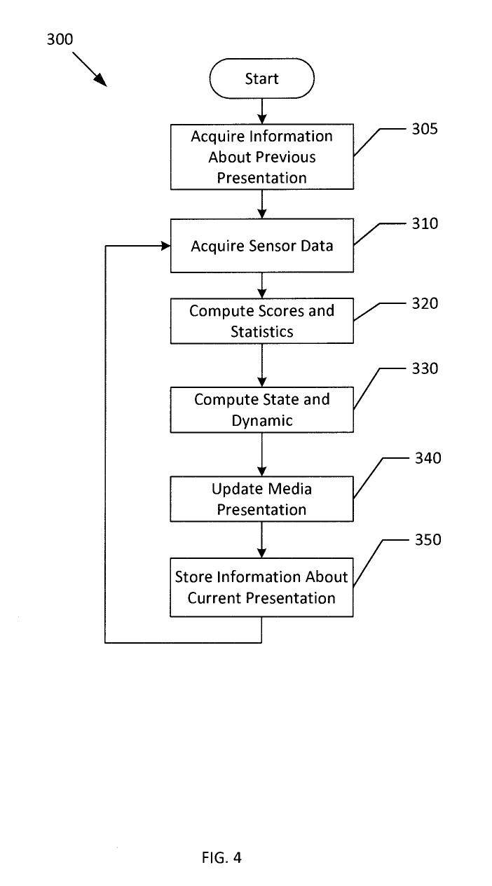

FIG. 4 illustrates another embodiment of method 300. This embodiment also includes, at 305, acquiring information about previous presentations and, at 350, storing information about the current presentation. The information about the previous presentations may facilitate planning or adapting the current presentation. The information about the current presentation may facilitate planning or adapting future presentations or other similar presentations happening at the same time, in parallel. “Similar,” in this context, refers to the same types of events, events marking the same occasion (e.g., New Years, World Cup of Soccer Final) events having demographics that fall within a threshold, events being experienced by people of the same culture, and so on. Storing information about a current presentation facilitates continuous enrichment of the knowledge base with detailed information about an event (e.g., market, culture, specific audience reaction, gamification data). This enriched knowledge base facilitates having a DDJ adapt to, for example, trends, seasonal patterns, or other conditions based on data acquired at other events.

While FIGS. 3 and 4 illustrate various actions occurring in serial, it is to be appreciated that various actions illustrated in FIGS. 3 and 4 could occur substantially in parallel. By way of illustration, a first process could acquire sensor data, a second process could compute gamification patterns, a third process could compute audience state or dynamics, and a fourth process could manipulate a presentation. While four processes are described, it is to be appreciated that a greater or lesser number of processes could be employed and that lightweight processes, regular processes, threads, and other approaches could be employed.

In one example, a method may be implemented as computer executable instructions. Thus, in one example, a computer-readable storage device may store computer executable instructions that if executed by a machine (e.g., computer) cause the machine to perform methods described or claimed herein including method 300. While executable instructions associated with the above methods are described as being stored on a computer-readable storage device, it is to be appreciated that executable instructions associated with other example methods described or claimed herein may also be stored on a computer-readable storage device. In different embodiments, the example methods described herein may be triggered in different ways. In one embodiment, a method may be triggered manually by a user. In another example, a method may be triggered automatically.

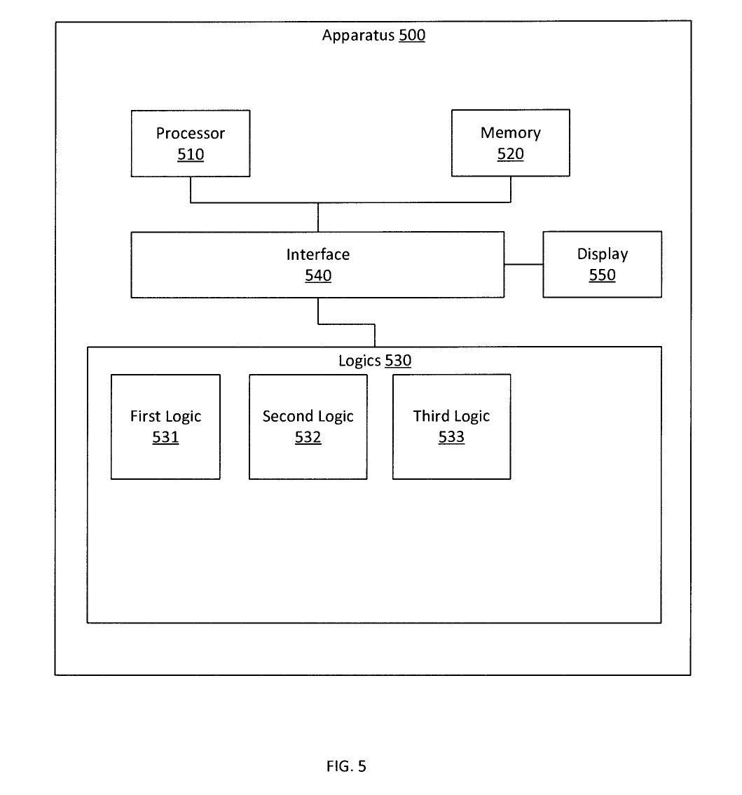

FIG. 5 illustrates an apparatus 500 (e.g., game console) that operates as a gamified digital disc jockey. Apparatus 500 may include a processor 510, a memory 520, a set 530 of logics, a display 550, and a hardware interface 540 that connects the processor 510, the memory 520, the display 550, and the set 530 of logics. The processor 510 may be, for example, a microprocessor in a computer, a specially designed circuit, a field-programmable gate array (FPGA), an application specific integrated circuit (ASIC), a processor in a mobile device, a system-on-a-chip, a dual or quad processor, or other computer hardware. The memory 520 may store data describing a music presentation to be made to an audience. The music presentation may have a number of audio tracks (e.g., songs) arranged in order in a mix.

Apparatus 500 may interact with other apparatus, processes, and services through, for example, a telephony system, a computer network, a data communications network, or voice communication network. Apparatus 500 may be, for example, a game console, a computer, a laptop computer, a tablet computer, a personal electronic device, a smart phone, a system-on-a-chip (SoC), or other device.

In one embodiment, the functionality associated with the set of logics 530 may be performed, at least in part, by hardware logic components including, but not limited to, FPGAs, ASICs, application specific standard products (ASSPs), SOCs, or complex programmable logic devices (CPLDs).

The set 530 of logics control the music presentation. Controlling the music presentation may include controlling audio equipment that plays the tracks in the mix. Controlling the music presentation may include controlling the order in which tracks are played, the length for which a track is played, a volume at which a track is played, and other attributes of the performance. The set 530 of logics may include a first logic 531 that determines a state of the audience and a dynamic of the audience. The state and dynamic of the audience are determined and updated while the audio track is playing. The state and dynamic of the audience are determined from electronic data received from a plurality of sensors while the audio track is playing. Unlike conventional systems that may adapt a track based on a reaction to a track, apparatus 500 may adapt a track and a mix based on a reaction to a series of tracks and on gamification scores or patterns. Unlike conventional systems that may seek to maximize the reaction to each track, apparatus 500 may seek to produce different peaks and valleys throughout the presentation.

The sensors may include, for example, a gesture sensor that identifies gestures from members of the audience. The gestures may include, for example, single gestures, collective gestures, appropriate gestures, inappropriate gestures, gestures that indicate approval, or gestures that indicate disapproval. A single gesture may be a one-time gesture that is made by one or a small number of audience members in isolation from other gestures. For example, a dancer may jump and pump a first upon hearing their favorite track start. A collective gesture may be a gesture that is made simultaneously or close in time by a large number of audience members. For example, a group of dancers may all wave their hands back and forth in the air during a rhythmic portion of a well-known track. In one embodiment, this type of collective gesture may be assessed against the beats per minute of the playing track to determine whether the collective gesture is due to the track. An appropriate gesture may be one that is known to be associated with a track. For example, certain tracks are associated with well-known dances that may include large, theatrical gestures (e.g., Hang on Sloopy and O-H-I-O). When the gesture matches the well-known dance then the gesture may be an appropriate gesture. When the gesture does not match the well-known dance, or when the gesture is associated with profanity (e.g., giving someone the finger), then the gesture may be an inappropriate gesture. Some gestures (e.g., thumbs up) may indicate approval while other gestures (e.g., thumbs down) may indicate disapproval. Gestures from certain individuals (e.g., event organizer, highly scored members) may be given more weight than other gestures. Over time, as the knowledge base grows, information about gesture patterns may continue to expand and information about their meaning or culture-specific meaning may be acquired. In one embodiment, a DDJ may present information about gestures to which the DDJ will respond. For example, the DDJ may display short videos of a “language” of gestures that indicate approval or disapproval. In different embodiments, the gesture special language may be communicated in other ways including, for example, through a party invitation, through online coverage of the event, or in other ways. These specific gestures may then be identified during a music presentation.

The sensors may also include a sound sensor that identifies sounds made by members of the audience. The sounds may include, for example, sounds of approval, sounds of disapproval, singing along, chanting, appropriate participatory interjections, or inappropriate participatory interjections. Sounds of approval may include, for example, clapping, people yelling “yes”, or other cheering noises. Sounds of disapproval may include, for example, people yelling “no”, or other jeering noises. Chanting or singing along may indicate that the audience knows the track and likes it well enough to join in. Certain tracks may have developed into “participatory” tracks where it is expected that the audience will chime in (e.g., interject) at certain points. When the audience likes the track, they may chime in with the appropriate lyrics. When the audience does not like the track, they may chime in with inappropriate (e.g., parody) lyrics. Sounds from certain individuals (e.g., event organizer, highly scored members) may be given more weight than other sounds. Over time, as the knowledge base grows, information about sounds or sound patterns may continue to expand and information about the meaning or culture-specific meaning of certain sounds may be acquired.

The sensors may also include a concurrency pattern sensor that identifies dance patterns in the audience. Sometimes a disc jockey may want people to pair off and dance as couples for a while. At other times the disc jockey may want a collective experience. Both types of experiences may be gauged by dance patterns. The dance patterns may include line dancing (e.g., Electric Slide), conga line dancing, partner dancing, choreographed dancing, or individual dancing. An audience reaction to a track may be gauged by the type of dancing it produces. For example, if a large percentage of the audience are all performing the same dance at the same time this may indicate approval. Similarly, a track that causes dancers to form a conga line may also indicate approval. Knowing that a track is likely to cause dancers to form a conga line may lead a disc jockey to either play or not play the track based on whether a conga line is desired at that time. Dance patterns from certain individuals (e.g., event organizer, highly scored members) may be given more weight than other dance patterns. In one embodiment, dance patterns may be assessed against the beats per minute of a track to identify group dance activity and also to indicate a quality of the dance. Over time, as the knowledge base grows, information about dance patterns may continue to expand and information about the meaning or culture-specific meaning of certain dance patterns may be acquired.

In one embodiment, the concurrency pattern sensor may consider inputs from different types of sensors. For example, a scream of excitement from one person can be random and thus indifferent, however the same type of scream from many people just after the start of a song may identify an excitement level. In one embodiment, the concurrency pattern sensor may be a process that applies post-processing to individual gestures to identify concurrent gestures.

The sensors may also include a facial pattern sensor that identifies facial expressions from members of the audience. The reaction of an audience to a track may be determined by whether people are smiling or whether people are frowning. More generally, the facial expressions may include facial expressions of approval and facial expressions of disapproval including strong reactions of excitement and frustration. Facial patterns or expressions from certain individuals (e.g., event organizer, highly scored members) may be given more weight than other facial patterns or expressions. Over time, as the knowledge base grows, information about facial patterns or expressions may continue to expand and information about the meaning or culture-specific meaning of certain facial patterns or expressions may be acquired.

The sensors provide information from which the state of the audience and the dynamics of the audience may be determined. The state of the audience may include a rich set of information about the people at the music presentation. For example, the state of the audience may include information about a number of people dancing, a percentage of people dancing, or a demographic of people dancing. While information about who is dancing is useful, information about people who aren't dancing may also be useful. Therefore the state of the audience may include information about a number of people sitting, a percentage of people sitting, or a demographic of people sitting. The information and state may be viewed in light of the expected audience reaction for a track. The expected audience reaction may be specific to different types of events or cultures. The expected audience reaction may be modelled over time from information acquired at other events by a DDJ. Thus, just because people aren't dancing doesn't mean that people aren't participating.

In addition to dancing or sitting, people at a music presentation may stand around, individually or in groups. If people are standing it may be easier to entice them on to the dance floor. Thus, the state of the audience may include information about a number of people standing alone, a percentage of people standing alone, a demographic of people standing alone, a number of people standing in groups, a percentage of people standing in groups, or a demographic of people standing in groups.

Conventional systems may identify how many people are dancing and how vigorously they are dancing. Apparatus 500 goes much further. Thus, the state of the audience may include information about a dance energy and a dance pattern. The dance energy may describe more than just how vigorously people are dancing. The dance energy may also describe whether the vigor with which people are dancing is inside a range or is widely dispersed, and whether the rate at which people are dancing matches the beat of the track. For example, one indicia of audience approval may be that a lot of people are all dancing the same way and in time with the track. When there is a consistent dance energy, it may be easier to sequence tracks to produce a desired dance energy at a future point in time. In one embodiment, a DDJ may quantify dance energy in a single number. Quantification may also be applied at the individual level, the group level, and at the audience level. The quantified dance energy may then be monitored against time and compared to similar events. In one embodiment, other properties of dance energy may also be computed. For example, the variance or homogeneity may also be computed and analyzed.

People dance in different patterns. For example, people may dance by themselves, may dance in small groups, may dance according to a well-known dance (e.g., the Chicken Dance, the Funky Chicken, the Twist), or may dance in a conga line. The named dance patterns may be maintained in the knowledge base. Thus, the state of the audience may include information about a number of people dancing individually, a percentage of people dancing individually, a demographic of people dancing individually, a number of people dancing in couples, a percentage of people dancing in couples, a demographic of people dancing in couples, a number of people dancing in a group, a percentage of people dancing in a group, or a demographic of people dancing in a group. Understanding the demographics of who is dancing, talking, sitting, or standing may facilitate manipulating the mix to be more inclusive so that all demographics get a chance to dance to music they like. Additionally, tracking and storing information about demographics may facilitate planning mixes for future events where the demographics are known. For example, a gamified adaptive digital disc jockey may play tracks that produce a first experience for people under twenty, then a second experience for people between twenty and forty, and then a third experience for people over forty. A gamified adaptive digital disc jockey may be able to estimate the demographic information for an audience using, for example, facial recognition. The demographic information may also be estimated from, for example, the type of event. The gamified adaptive digital disc jockey may then update the mix based on this information.

Conventional systems may determine an instantaneous audience reaction to an individual track based on information that does not consider demographics. While this is interesting and useful, it is severely limited when an overall music presentation experience is concerned. A good experience may be determined not just by an individual track at an individual time, but by the overall experience produced by sequences of tracks that produce different responses at different times by different subsets of the audience. For example, a dance may be a more enjoyable experience when there is a flow of partner dancing, group dancing, fast dancing, slow dancing, and singalongs. Thus, the sensors provide information from which dynamics can be determined. The dynamic of the audience may include information about a change in state of the audience. Thus, the dynamic may include information about a change in a number of people dancing, a change in a percentage of people dancing, a change in a demographic of people dancing, a change in a number of people sitting, a change in a percentage of people sitting, or a change in a demographic of people sitting. While an individual track may cause people to get up and dance or to stop dancing, a sequence of tracks may have a more consistent impact. Sequences of tracks may also bring people together in small groups or get them to act collectively as a large group. Thus, the dynamic may include information about a change in a number of people standing alone, a change in a percentage of people standing alone, a change in a demographic of people standing alone, a change in a number of people standing in groups, a change in a percentage of people standing in groups, a change in a demographic of people standing in groups, a change in a number of people dancing individually, a change in a percentage of people dancing individually, a change in a demographic of people dancing individually, a change in a number of people dancing in couples, a change in a percentage of people dancing in couples, a change in a demographic of people dancing in couples, a change in a number of people dancing in a group, a change in a percentage of people dancing in a group, or a change in a demographic of people dancing in a group.

Certain sequences of tracks may cause dance energy to increase while others may cause dance energy to decrease. Both may be desirable or undesirable depending on how the disc jockey or event organizer wants the event to proceed. Thus, the dynamic may include information about a change in dance energy or a change in dance patterns. In one embodiment, apparatus 500 may have information describing an abstract lifecycle for a type of event. In one embodiment, the information may provide context concerning a market, a culture, a demographic or other attribute. Apparatus 500 may have information that can explain a decrease/increase in dancing/energy patterns by the song in isolation and/or by a point in the lifecycle of an event. For example, by comparing the expected lifecycle in terms of audience size and participation to the actual audience size and participation time series, the DDJ may identify that a drop in energy, reaction, participation is expected and is not due to song selection or that an increase in energy, reaction, or participation is expected and produces a good fit with the expected result. In the example of an underperforming audience, a fit with the expected curve, could mean that this is due to the fact that people are getting tired, that it's getting late and people are leaving, that the audience size has been reduced or other natural, uncontrolled factors.

The set 530 of logics may also include a second logic 532 that determines a gamification score for a member of the audience. In one embodiment, the gamification score is determined while the track is playing and thus may be available to amend the track or mix in real time. The gamification scores may be based, at least in part, on electronic data received from the plurality of sensors while the audio track is playing. While a person's reaction to a track at any given point in time may be captured in static data (e.g., person is or is not dancing, person is dancing at a certain level), the gamification scores may reflect how the person is reacting over time, and how the person is reacting as compared to other people at the dance. In one embodiment, the gamification scores may reflect how the person is reacting as compared to other events in which the person participated, baselines across other similar events, or in other ways.

In one embodiment, a gamification score for a particular member of the audience is computed from the actions or reactions of the member over time. Actions from which a gamification score may be computed may include how much the particular audience member is dancing or how much the particular audience member is talking. A person who is dancing the most may be identified as a dance leader while a person who is talking the most and dancing the least may be identified as a social leader but a dance laggard. The gamification score may be based not just on volume of dancing but on quality of dancing. For example, the gamification score may be based on how well the particular audience member is dancing, how energetically the particular audience member is dancing, how elegantly the particular audience member is dancing, or how appropriately the particular audience member is dancing. An audience member who is energetically and precisely performing the right dance for a track may be identified as a dance leader. An audience member who is making a half-hearted attempt and messing up most of the dance moves may be identified as a dance laggard.

The gamification score may also concern the types of interactions a person is having. For example, the gamification score may concern the heterogeneity of the partners with whom the particular audience member is dancing or the heterogeneity of the partners with whom the particular audience member is talking. A person who talks and dances with the widest variety of people may be identified as an inclusiveness leader. The gamification score may also depend, for example, on the popularity of the partners with whom the particular audience member is dancing, or the popularity of the partners with whom the particular audience member is talking. A person who only talks with the most popular people may receive one type of gamification rating while a person who talks with people regardless of whether they are popular may receive a different type of gamification rating.

In one embodiment, gamification scores may concern comparisons. The comparisons may concern, for example, audience, member, or event performance statistics between events or within an event. These types of gamification scores facilitate producing rankings (e.g, top x in z for attribute y). These types of gamification scores may also facilitate computation of overall performance scores using statistical formulas.

In one embodiment, the second logic 532 provides information about game leaders or game laggards during the music presentation. In another embodiment, the second logic 532 provides information about game leaders or game laggards after the music presentation. Providing the information may include, for example, displaying the individual on a screen visible to the attendees during the music presentation, sending a text message or other electronic notification about the game leader, storing data about the individual, or other action. In one embodiment, the second logic 532 may provide a reward to a game leader during or after the music presentation. The reward may be, for example, the ability to request a track, the ability to have a request prioritized, exposure time on a video display, some physical token, some virtual token, or other reward. Additionally, the second logic 532 may provide an incentive to a game laggard during the music presentation. The incentive may be, for example, an opportunity to request a track, an opportunity to dance with a particular partner, or other incentive. In one embodiment, information about leaders or laggards or about the music presentation itself may be provided to people who are at the event or even not at the event. Providing information about the dance energy at a party and who the dance leaders are at the party may incentivize other people to come to the party.

Once leaders or laggards have been identified, apparatus 500 may perform actions that conventional systems do not perform. For example, the third logic 533 may automatically manipulate the music presentation based on a reaction of the game leaders or game laggards rather than on an overall (e.g., average) audience reaction. In this way, the overall experience may be individualized in a way that is impossible with conventional systems. In one embodiment, the third logic 533 may automatically manipulate the music presentation based on an overall gamified music presentation score, on a combination of individual gamification scores, or on a combination of individual scores and an overall score.

The set 530 of logics may also include a third logic 533 that automatically selectively manipulates the music presentation. The manipulation may be based on the state of the audience, on the dynamic of the audience, and on a gamification scores for one or more members of the audience. Unlike conventional systems that may add or remove a later track based on the reaction to a current track, apparatus 500 may add or remove a later track based on the reaction to a series of tracks, based on changes that a track produces, and based on the gamification scores produced during the track or series of tracks. In one embodiment, a track may be added or removed based, for example, on the overall success of the event so far in comparison with expected results or success. In one embodiment, a track may be added or removed based, for example, on the overall success of the music presentation so far in comparison with other music presentations. In one embodiment, a track may even be repeated based on gamification scores.

Conventional systems may act in a vacuum where all decisions are made from scratch and are based on reactions to an individual track. Apparatus 500 facilitates planning and optimizing an overall experience, rather than just reacting to individual tracks. In one embodiment, the overall experience may be planned based on information provided by an organizer of an event. In another embodiment, the overall experience may be planned in the absence of any such information. Thus, in one embodiment, the memory 520 may also store a desired audience trajectory for the music presentation. The desired audience trajectory describes a series of audience states and audience dynamics desired at different times during the music presentation. In this embodiment, the third logic 533 automatically selectively manipulates the music presentation based on the state of the audience, on the dynamic of the audience, on a series of gamification scores for one or more members of the audience, and on the desired audience trajectory.

The third logic 533 may also have information from previous presentations available. When this additional information is available in a repository of mix data, the third logic 533 may selectively manipulate the music presentation based on the data from the repository of mix data. The repository of mix data may store data describing instantaneous relationships and sequential relationships. The instantaneous relationships may include, for example, a relationship between a track and a state of an audience, a relationship between a track and a dynamic of an audience, or a relationship between a track and a gamification score or state. The sequential relationships may include, for example, a relationship between a sequence of tracks and a state of an audience, a relationship between a sequence of tracks and a dynamic of an audience, or a relationship between a sequence of tracks and a gamification score. Conventional systems may examine a reaction to a track being played and update that track or a subsequent track. However, conventional systems do not analyze and store information about reactions and changes in gamification scores or states produced by sequences of tracks. In one embodiment, the data concerning the instantaneous and sequential relationships may include statistical associations that take into account event types, cultures, demographics, or other attributes. In this embodiment, the third logic 533 may make decisions based on those statistical associations.

In one embodiment, the third logic 533 manipulates the music presentation by changing the amount of time for which a current track will be played or by changing the volume at which the current track will be played. A current track may be allowed to run longer, may be turned up, or may be turned down or ended. The current track is the track that generated the state and dynamic of the audience, and that generated the gamification scores for members of the audience.

The third logic 533 may also change the length of time or volume for a subsequent track in the mix. Conventional systems may add or remove tracks from a mix, but do not appear to change the order in which subsequent tracks in the mix will be played based on changes in gamification scores. Controlling the order, as facilitated by having both state and dynamic information available, may produce a superior experience when compared to a disc jockey that manipulates a mix on a per track basis.

In one embodiment, apparatus 500 is a game console and at least one of the plurality of sensors is integrated into the game console.

In one embodiment, the music presentation may include sample periods and performance periods. In this embodiment, the third logic 533 does not manipulate the music presentation during the one or more sample periods.

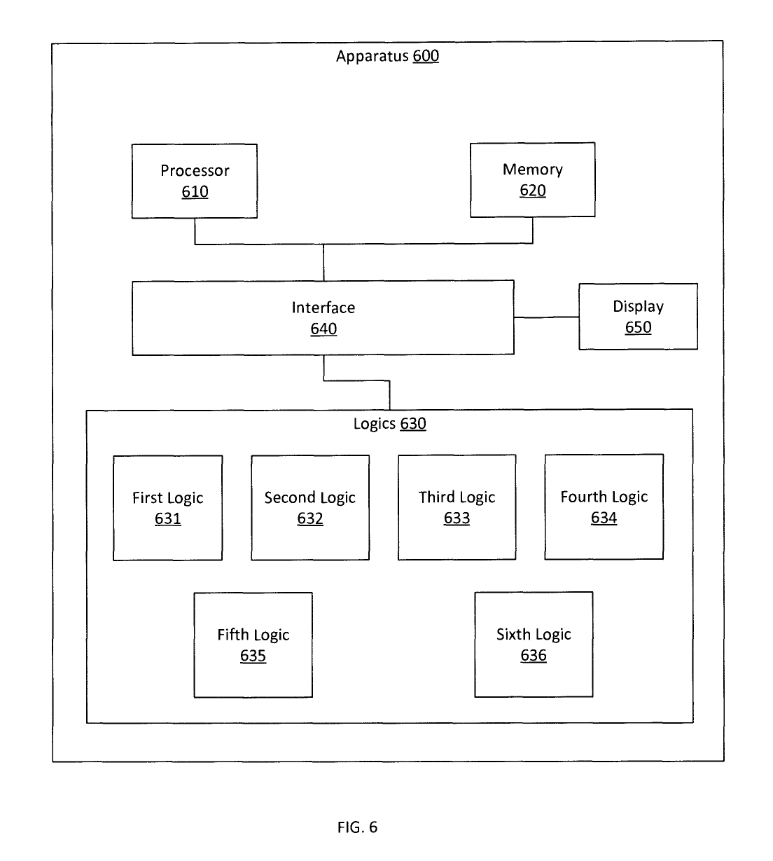

FIG. 6 illustrates an apparatus 600 that is similar to apparatus 500 (FIG. 5). For example, apparatus 600 includes a processor 610, a memory 620, a set of logics 630 that correspond to the set of logics 530 (FIG. 5), a display 650, and an interface 640.

However, apparatus 600 also includes a fourth logic 634 that receives a request for a requested track from a requestor. The request may be placed before the event or may arrive during the event. The fourth logic 634 may establish an initial position in the mix for the requested track. The initial position may be based, at least in part, on gamification scores associated with the requestor. For example, a request from a game leader or from a game laggard or a person whose score is trending upwards may be placed earlier in the mix while a request from someone who is in the middle of the pack with respect to gamification scores or whose score is trending downwards may be placed later in the mix. In one embodiment, the fourth logic 634 manipulates the position in the mix for the requested track based on gamification scores concerning the request. Gamification scores concerning the request may be determined from request data retrieved from the plurality of sensors in response to the request being presented to the audience. For example, a request may be posted to a video display board or texted to members of the audience. Responses to the request (e.g., cheers, jeers, gestures) may be acquired with respect to the request and gamification scores may be computed with respect to various members of the audience.

Apparatus 600 also includes a fifth logic 635 that selectively acquires a photograph, video, or sound recording for one or more audience members. The selected audience members may be, for example, a game leader, a game laggard, a dance organizer, an event organizer, a designated person, or another person. In one embodiment, the fifth logic 635 may acquire a recording of a natural arrangement of people around a leader. The photograph, video or sound recording may be acquired at a selected time determined, at least in part, by the state of the audience, the dynamic of the audience, or the gamification score for the selected audience member. For example, the selected time may be determined by the gamification score for the selected audience member achieving a threshold value (e.g., becoming a game leader), by the state of the audience achieving a pre-determined state characteristic (e.g., dance energy exceeds a threshold, percentage of people dancing exceeds a threshold), or by the dynamic of the audience achieving a pre-determined dynamic characteristic (e.g., dance energy increasing by a threshold amount, dance demographics changing by a desired amount).

Apparatus 600 may also include a sixth logic 636 that causes the repository of mix data to be updated with data acquired during the music presentation. Capturing state, dynamic, or gamification data during the music presentation may facilitate improving a subsequent music presentation. The data acquired during the music presentation may include, for example, data describing a relationship between a track and a state of an audience, data describing a relationship between a track and a dynamic of an audience, or data describing a relationship between a track and a gamification score. While these instantaneous values are interesting, sixth logic 636 may also acquire and store data describing a relationship between a sequence of tracks and a state of an audience, data describing a relationship between a sequence of tracks and a dynamic of an audience, or data describing a relationship between a sequence of tracks and a gamification score. Understanding states or dynamics that are produced by a series of tracks may provide superior insights into planning a dance than simply understanding the reaction to any individual track. The reaction to an individual track may need to be evaluated in light of who is already dancing.

In one embodiment, the sixth logic 636 causes the repository of mix data and the knowledge base to be updated with data about the mix. The data about the mix may describe a mix that was planned for the music presentation and may describe a mix that was actually played during the music presentation. While a conventional system may store a playlist and even make the most popular tracks available, apparatus 600 goes further. For example, when a desired trajectory for the event is available, the sixth logic 636 may store a correlation between a mix played during the music presentation and a desired trajectory associated with the music presentation. This may facilitate planning future events.

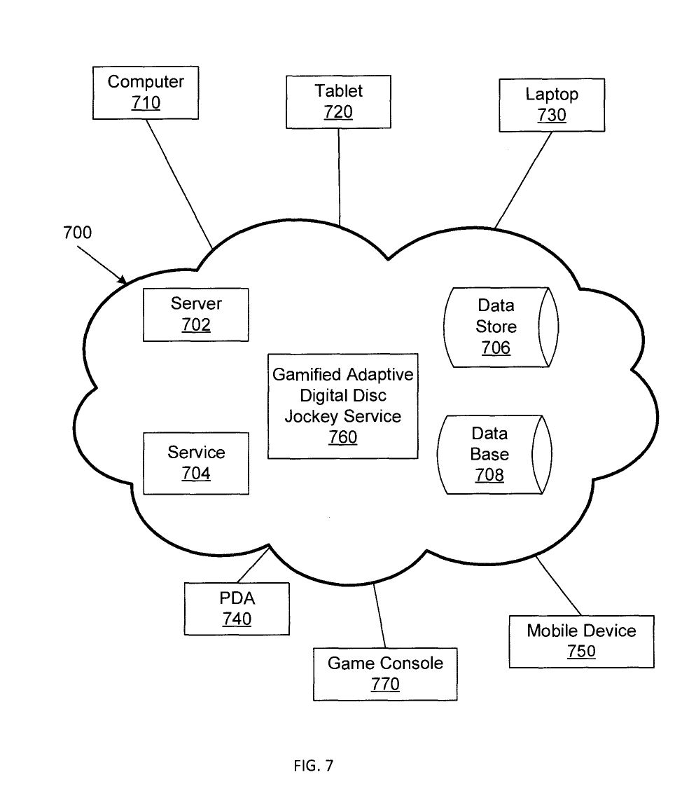

FIG. 7 illustrates an example cloud operating environment 700. A cloud operating environment 700 supports delivering computing, processing, storage, data management, applications, and other functionality as an abstract service rather than as a standalone product. Services may be provided by virtual servers that may be implemented as one or more processes on one or more computing devices. In some embodiments, processes may migrate between servers without disrupting the cloud service. In the cloud, shared resources (e.g., computing, storage) may be provided to computers including servers, clients, and mobile devices over a network. Different networks (e.g., Ethernet, Wi-Fi, 802.x, cellular) may be used to access cloud services. Users interacting with the cloud may not need to know the particulars (e.g., location, name, server, database) of a device that is actually providing the service (e.g., computing, storage). Users may access cloud services via, for example, a web browser, a thin client, a mobile application, or in other ways.

FIG. 7 illustrates an example gamified adaptive digital disc jockey service 760 residing in the cloud. The gamified adaptive digital disc jockey service 760 may rely on a server 702 or service 704 to perform processing and may rely on a data store 706 or database 708 to store data. While a single server 702, a single service 704, a single data store 706, and a single database 708 are illustrated, multiple instances of servers, services, data stores, and databases may reside in the cloud and may, therefore, be used by the gamified digital disc jockey service 760.

FIG. 7 illustrates various devices accessing the gamified adaptive digital disc jockey service 760 in the cloud. The devices include a computer 710, a tablet 720, a laptop computer 730, a personal digital assistant 740, a mobile device (e.g., cellular phone, satellite phone, wearable computing device) 750, and a game console 770. The service 760 may control a computer to present a media presentation to an audience. The service 760 may control the computer to compute various values during the media presentation. For example, the service 760 may compute a gamification pattern associated with members of the audience and may compute a level of approval of the audience during the media presentation. Once the approval level and gamification pattern are available, the service 760 may control the computer to selectively automatically update the media presentation during the media presentation.

In one embodiment, the media presentation is updated to increase a likelihood that a subsequent level of approval of the audience during the media presentation will approach a desired level. The media presentation may be updated by changing the amount of time for which an element of the media presentation will be presented, by changing the volume at which an element of the media presentation will be presented, and by changing the order in which one or more elements of the media presentation will be presented.

The service 760 may collect data from a variety of sensors and then compute the gamification pattern and the level of audience approval from the data. The sensors may include a gesture sensor that identifies gestures from members of the audience, a sound sensor that identifies sounds from members of the audience, a concurrency pattern sensor that identifies movement patterns (e.g., coordinated dancing) in the audience, and a facial pattern sensor that identifies facial expressions from members of the audience. The service 760 may also rely on data associated with a media presentation made at a previous time.

It is possible that different users at different locations using different devices may access the gamified adaptive digital disc jockey service 760 through different networks or interfaces. In one example, the service 760 may be accessed by a mobile device 750. In another example, portions of service 760 may reside on a mobile device 750.

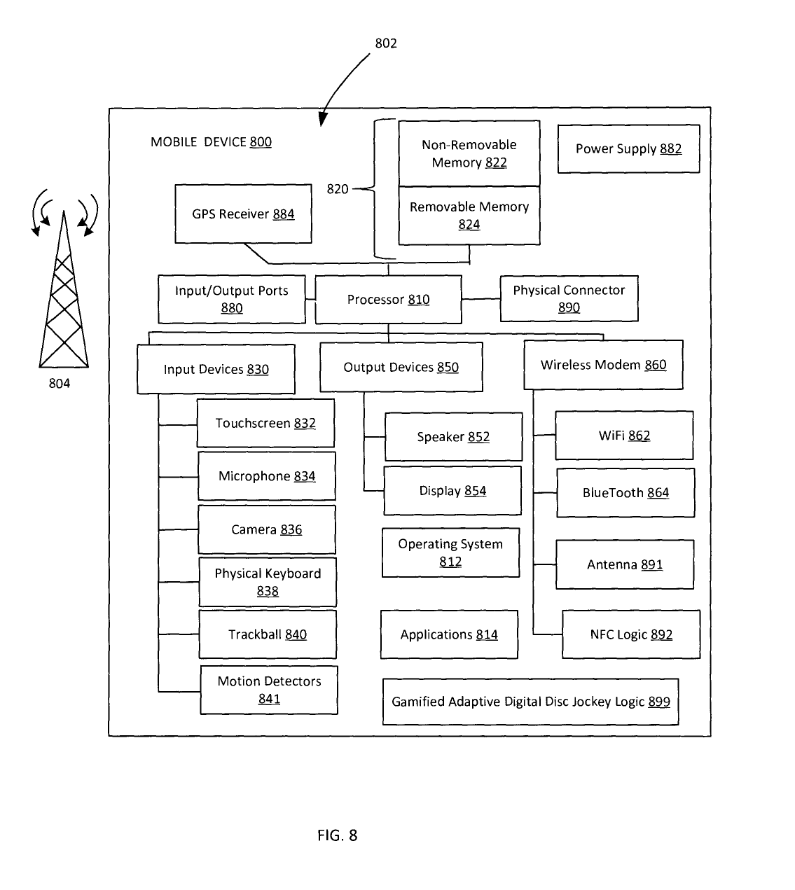

FIG. 8 is a system diagram depicting an exemplary mobile device 800 that includes a variety of optional hardware and software components, shown generally at 802. Components 802 in the mobile device 800 can communicate with other components, although not all connections are shown for ease of illustration. The mobile device 800 may be a variety of computing devices (e.g., cell phone, smartphone, handheld computer, Personal Digital Assistant (PDA), wearable computing device, game console) and may allow wireless two-way communications with mobile communications networks 804 (e.g., cellular network, satellite network).

Mobile device 800 may include a controller or processor 810 (e.g., signal processor, microprocessor, ASIC, or other control and processing logic circuitry) for performing tasks including signal coding, data processing, input/output processing, power control, or other functions. An operating system 812 can control the allocation and usage of the components 802 and support application programs 814.

Mobile device 800 can include memory 820. Memory 820 can include non-removable memory 822 or removable memory 824. The non-removable memory 822 can include random access memory (RAM), read only memory (ROM), flash memory, a hard disk, or other memory storage technologies. The removable memory 824 can include flash memory or a Subscriber Identity Module (SIM) card, which is well known in GSM communication systems, or other memory storage technologies, such as “smart cards.” The memory 820 can be used for storing data or code for running the operating system 812 and the applications 814. Example data can include a mix, data about tracks in the mix, gamification patterns or scores, a desired event trajectory, or other data. The memory 820 can be used to store a subscriber identifier, such as an International Mobile Subscriber Identity (IMSI), and an equipment identifier, such as an International Mobile Equipment Identifier (IMEI). The identifiers can be transmitted to a network server to identify users or equipment.

The mobile device 800 can support input devices 830 including, but not limited to, a touchscreen 832, a microphone 834, a camera 836, a physical keyboard 838, or trackball 840. The mobile device 800 may also support output devices 850 including, but not limited to, a speaker 852 and a display 854. Other possible output devices (not shown) can include piezoelectric or other haptic output devices. Some devices can serve more than one input/output function. For example, touchscreen 832 and display 854 can be combined in a single input/output device. The input devices 830 can include a Natural User Interface (NUI). An NUI is an interface technology that enables a user to interact with a device in a “natural” manner, free from artificial constraints imposed by input devices such as mice, keyboards, remote controls, and others. Examples of NUI methods include those relying on speech recognition, touch and stylus recognition, gesture recognition (both on screen and adjacent to the screen), air gestures, head and eye tracking, voice and speech, vision, touch, gestures, and machine intelligence. Other examples of a NUI include motion gesture detection using accelerometers/gyroscopes, facial recognition, three dimensional (3D) displays, head, eye, and gaze tracking, immersive augmented reality and virtual reality systems, all of which provide a more natural interface, as well as technologies for sensing brain activity using electric field sensing electrodes (EEG and related methods). Thus, in one specific example, the operating system 812 or applications 814 can include speech-recognition software as part of a voice user interface that allows a user to operate the device 800 via voice commands. Further, the device 800 can include input devices and software that allow for user interaction via a user's spatial gestures, such as detecting and interpreting gestures to provide input to a gamified adaptive digital disc jockey. The input devices 830 may also include motion sensing input devices (e.g., motion detectors 841).

A wireless modem 860 can be coupled to an antenna 891. In some examples, radio frequency (RF) filters are used and the processor 810 need not select an antenna configuration for a selected frequency band. The wireless modem 860 can support two-way communications between the processor 810 and external devices. The modem 860 is shown generically and can include a cellular modem for communicating with the mobile communication network 804 and/or other radio-based modems (e.g., Bluetooth 864 or Wi-Fi 862). The wireless modem 860 may be configured for communication with one or more cellular networks, such as a Global system for mobile communications (GSM) network for data and voice communications within a single cellular network, between cellular networks, or between the mobile device and a public switched telephone network (PSTN). NFC logic 892 facilitates having near field communications (NFC).

The mobile device 800 may include at least one input/output port 880, a power supply 882, a satellite navigation system receiver 884, such as a Global Positioning System (GPS) receiver, or a physical connector 890, which can be a Universal Serial Bus (USB) port, IEEE 1394 (FireWire) port, RS-232 port, or other port. The illustrated components 802 are not required or all-inclusive, as other components can be deleted or added.

Mobile device 800 may include a gamified disc jockey logic 899 that is configured to provide a functionality for the mobile device 800. For example, logic 899 may provide a client for interacting with a service (e.g., service 760, FIG. 7). Portions of the example methods described herein may be performed by logic 899. Similarly, logic 899 may implement portions of apparatus described herein. Gamified disc jockey logic 899 may receive data about audience members and determine a state and dynamic of the audience in response to a portion of the media presentation. The logic 899 may identify audience leaders or laggards from gamification data or patterns about audience members. The logic 899 may automatically adapt the media presentation based on the state and dynamic of the audience in general and/or based on the reactions of audience leaders or laggards. The logic 899 may consider a desired audience trajectory for a mix of tracks and manipulate the mix to achieve desired dance energy or participation levels at particular points in time. Data relating states, dynamics, gamification scores, and tracks or sequences of tracks about previous presentations may be used to plan the presentation and may be stored for planning future presentations.

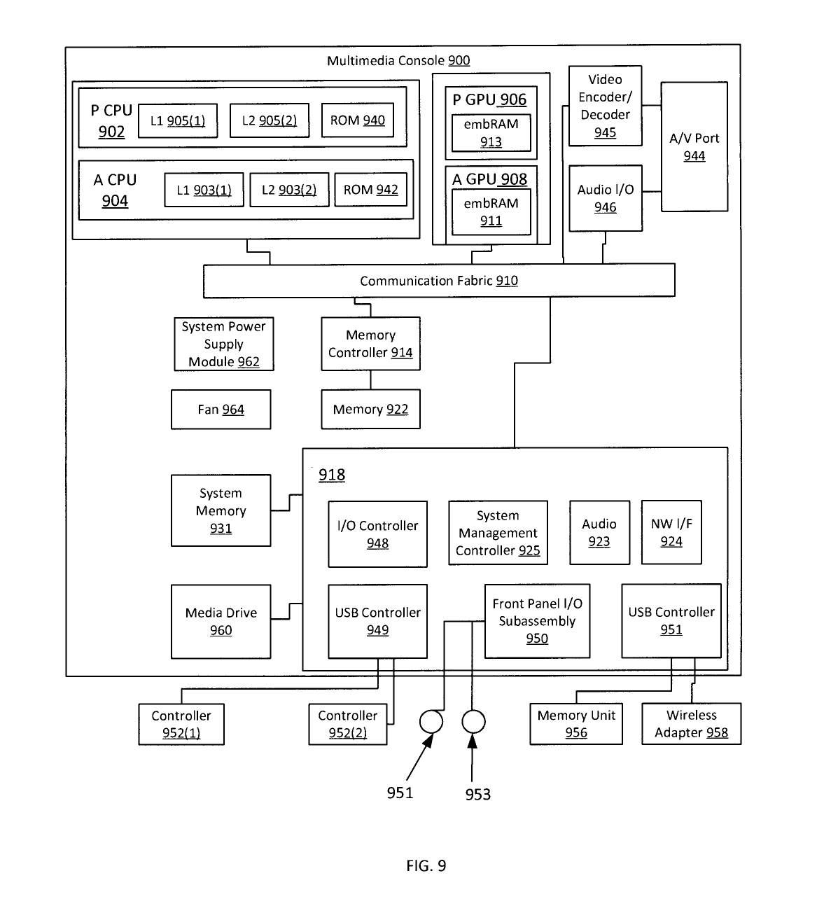

FIG. 9 illustrates an example embodiment of a multimedia computer system architecture with scalable platform services. A multimedia console 900 has a platform CPU 902 and an application CPU 904. For ease of connections in the drawings, the CPUs are illustrated in the same module, however, they may be separate units and share no cache or ROM. Platform CPU 902 may be a single core processor or a multicore processor. In this example, the platform CPU 902 has a level 1 cache 905(1) and a level 2 cache 905(2) and a flash ROM 904.

The multimedia console 900 further includes the application CPU 904 for performing multimedia application functions (e.g., gamified adaptive digital disc jockey). CPU 904 may also include one or more processing cores. In this example, the application CPU 904 has a level 1 cache 903(1) and a level 2 cache 903(2) and a flash ROM 942.

The multimedia console 900 further includes a platform graphics processing unit (GPU) 906 and an application graphics processing unit (GPU) 908. For ease of connections in the drawings, the GPUs are illustrated in the same module, however they may be separate units and share no memory structures. Each GPU may have its own embedded RAM 911, 913.

The CPUs 902, 904, GPUs 906, 908, memory controller 914, and various other components within the multimedia console 900 are interconnected via one or more buses, including serial and parallel buses, a memory bus, a peripheral bus, and a processor or local bus a bus architecture. By way of example, the bus architectures can include a Peripheral Component Interconnects (PCI) bus, PCI-Express bus, etc. for connection to an IO chip and/or as a connector for future IO expansion. Communication fabric 910 is representative of the various busses or communication links that also have excess capacity.

In this embodiment, each GPU and a video encoder/decoder (codec) 945 may form a video processing pipeline for high speed and high resolution graphics processing. Data from the embedded RAM 911, 913 or GPU 906, 908 is stored in memory 922. Video codec 945 accesses the data in memory 922 via the communication fabric 910. The video processing pipeline outputs data to an A/V (audio/video) port 944 for transmission to a television or other display.

Lightweight messages (e.g., pop ups) generated by an application, for example a gamified adaptive disc jockey application, are created by using the GPU to schedule code to render the popup into an overlay video plane. The amount of memory used for an overlay plane depends on the overlay area size, which preferably scales with screen resolution. Where a full user interface is used by the concurrent platform services application, it is preferable to use a resolution independent of application resolution. A scaler may be used to set this resolution so that the need to change frequency and cause a TV resync is eliminated.

A memory controller 914 facilitates processor access to various types of memory 922, including, but not limited to, one or more DRAM (Dynamic Random Access Memory) channels.

The multimedia console 900 includes an I/O controller 948, a system management controller 925, an audio processing unit 923, a network interface controller 924, a first USB host controller 949, a second USB controller 951, and a front panel I/O subassembly 950 that are preferably implemented on a module 918. The USB controllers 949 and 951 serve as hosts for peripheral controllers 952(1)-952(2), a wireless adapter 958, and an external memory device 956 (e.g., flash memory, external CD/DVD ROM drive, memory stick, removable media, etc.). The network interface 924 and/or wireless adapter 958 provide access to a network (e.g., the Internet, home network, etc.) and may be various wired or wireless adapter components including an Ethernet device, a modem, a Bluetooth module, or a cable modem.

System memory 931 is provided to store application data that is loaded during the boot process. The application data may be, for example, tracks available for a mix, metadata about tracks and mixes from previous presentations, state data, dynamic data, or other data. A media drive 960 is provided and may be a DVD/CD drive, Blu-Ray drive, hard disk drive, or other removable media drive, etc. The media drive 960 may be internal or external to the multimedia console 900. Application data may be accessed via the media drive 960 for execution, playback, or other actions by the multimedia console 900. The media drive 960 is connected to the I/O controller 948 via a bus, such as a Serial ATA bus or other high speed connection (e.g., IEEE 1394).

The system management controller 925 provides a variety of service functions related to assuring availability of the multimedia console 900. The audio processing unit 923 and an audio codec 946 form a corresponding audio processing pipeline with high fidelity and stereo processing. Audio data is stored in memory 922 and accessed by the audio processing unit 923 and the audio input/output unit 946 that form a corresponding audio processing pipeline with high fidelity stereo and multichannel audio processing. When a concurrent platform services application wants audio, audio processing may be scheduled asynchronously to the gaming application due to time sensitivity. The audio processing pipeline outputs data to the AN port 944 for reproduction by an external audio user or device having audio capabilities.

The front panel I/O subassembly 950 supports the functionality of the power button 951 and the eject button 953, as well as any LEDs (light emitting diodes) or other indicators exposed on the outer surface of the multimedia console 900. A system power supply module 962 provides power to the components of the multimedia console 900. A fan 964 cools the circuitry within the multimedia console 900.

The multimedia console 900 may be operated as a standalone system by simply connecting the system to a television or other display. In this standalone mode, the multimedia console 900 allows one or more users to interact with the system, watch movies, listen to music, or engage in other activities. However, with the integration of broadband connectivity made available through the network interface 924 or the wireless adapter 958, the multimedia console 900 may further be operated as a participant in a larger network community.

After multimedia console 900 boots and system resources are reserved, concurrent platform services applications execute to provide platform functionalities. The platform functionalities are encapsulated in a set of platform applications that execute within the reserved system resources described above. The operating system kernel identifies threads that are platform services application threads versus gaming application threads.

Optional input devices (e.g., controllers 952(1) and 952(2)) are shared by gaming applications, system applications, and other applications (e.g., gamified adaptive digital disc jockey). The input devices may be switched between platform applications and the gaming application so that each can have a focus of the device. The I/O controller 948 may control the switching of input stream, and a driver may maintain state information regarding focus switches.

### Aspects of Certain Embodiments

In one embodiment, an apparatus controls media equipment (e.g., sound system, video system) to present a media presentation to an audience. The apparatus also controls a computer to compute, during the media presentation, a gamification pattern associated with members of the audience during the media presentation. The apparatus also controls a computer to compute, during the media presentation, a level of approval of the audience during the media presentation. The apparatus also controls the computer to selectively automatically update the media presentation during the media presentation in response to the gamification pattern and the level of approval of the audience. The media presentation is updated to increase a likelihood that a subsequent level of approval of the audience during the media presentation will approach a desired level. The media presentation is updated by changing the amount of time for which an element of the media presentation will be presented, by changing the volume at which an element of the media presentation will be presented, and by changing the order in which one or more elements of the media presentation will be presented. The gamification pattern and the level of audience approval are determined from data provided by a variety of sensors. The data may include data provided by a gesture sensor that identifies gestures from members of the audience, data provided by a sound sensor that identifies sounds from members of the audience, data provided by a concurrency pattern sensor that identifies movement patterns in the audience, data provided by a facial pattern sensor that identifies facial expressions from members of the audience, and data associated with a media presentation made at a previous time. The data may also include data provided by a motion pattern detection sensor that listens to motion data submitted by sensors carried by members of the audience.

An example gamified adaptive digital disc jockey produces a technical effect of improving the efficiency of a sound or video presentation system. Less electricity and fewer computing resources are used to produce a seamless media presentation that produces audience states and dynamics that conform to a desired trajectory. By conforming to the desired trajectory, desired states are achieved without having to make extra switches to media being presented. Additionally, the global nature of a gamified adaptive DDJ may shorten the preparation time for events by requiring less searching of music databases or event data. Since the knowledge base is available, less network bandwidth may be consumed looking for appropriate tracks for a mix.

### Definitions

The following includes definitions of selected terms employed herein. The definitions include various examples or forms of components that fall within the scope of a term and that may be used for implementation. The examples are not intended to be limiting. Both singular and plural forms of terms may be within the definitions.

References to “one embodiment”, “an embodiment”, “one example”, and “an example” indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

“Computer-readable storage device”, as used herein, refers to a device that stores instructions or data. “Computer-readable storage device” does not refer to propagated signals. A computer-readable storage device may take forms, including, but not limited to, non-volatile media, and volatile media. Non-volatile media may include, for example, optical disks, magnetic disks, tapes, and other media. Volatile media may include, for example, semiconductor memories, dynamic memory, and other media. Common forms of a computer-readable storage devices may include, but are not limited to, a floppy disk, a flexible disk, a hard disk, a magnetic tape, other magnetic medium, an application specific integrated circuit (ASIC), a compact disk (CD), a random access memory (RAM), a read only memory (ROM), a memory chip or card, a memory stick, and other media from which a computer, a processor or other electronic device can read.

“Data store”, as used herein, refers to a physical or logical entity that can store data. A data store may be, for example, a database, a table, a file, a list, a queue, a heap, a memory, a register, and other physical repository. In different examples, a data store may reside in one logical or physical entity or may be distributed between two or more logical or physical entities.

“Logic”, as used herein, includes but is not limited to hardware, firmware, software in execution on a machine, or combinations of each to perform a function(s) or an action(s), or to cause a function or action from another logic, method, or system. Logic may include a software controlled microprocessor, a discrete logic (e.g., ASIC), an analog circuit, a digital circuit, a programmed logic device, a memory device containing instructions, and other physical devices. Logic may include one or more gates, combinations of gates, or other circuit components. Where multiple logical logics are described, it may be possible to incorporate the multiple logical logics into one physical logic. Similarly, where a single logical logic is described, it may be possible to distribute that single logical logic between multiple physical logics.

To the extent that the term “includes” or “including” is employed in the detailed description or the claims, it is intended to be inclusive in a manner similar to the term “comprising” as that term is interpreted when employed as a transitional word in a claim.

To the extent that the term “or” is employed in the detailed description or claims (e.g., A or B) it is intended to mean “A or B or both”. When the Applicant intends to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

Although the subject matter has been described in language specific to structural features or methodological acts, it is to be understood that the subject matter defined in the appended claims is not necessarily limited to the specific features or acts described above. Rather, the specific features and acts described above are disclosed as example forms of implementing the claims.

What is claimed is:

1. A gamified adaptive digital disc jockey apparatus, comprising:
a processor;
a memory that stores data describing a music presentation to be made to an audience, where the music presentation comprises a mix of audio tracks;
a set of logics that control the music presentation; and
a hardware interface to connect the processor, the memory, and the set of logics;
the set of logics comprising:
a first logic that determines, while an audio track in the mix is playing, a state of the audience and a dynamic of the audience, where the state of the audience and the dynamic of the audience are determined based, at least in part, on electronic data received from a plurality of sensors while the audio track is playing;
a second logic that determines one or more gamification scores for one or more members of the audience, where the one or more gamification scores are determined while the audio track is playing, based, at least in part, on electronic data received from one or more members of the plurality of sensors while the audio track is playing; and
a third logic that automatically selectively manipulates the music presentation based, at least in part, on the state of the audience, on the dynamic of the audience, and on the one or more gamification scores for one or more members of the audience.

2. The apparatus of claim 1, where the memory stores a desired audience trajectory for the music presentation, where the desired audience trajectory describes a series of audience states and audience dynamics desired at different times during the music presentation, and
where the third logic automatically selectively manipulates the music presentation, in-real-time, based, at least in part, on the state of the audience, on the dynamic of the audience, on a gamification score for one or more members of the audience, and on the desired audience trajectory.

3. The apparatus of claim 2, where the third logic selectively manipulates the music presentation based, at least in part, on data from a repository of mix data, where the repository of mix data stores data acquired during one or more previous music presentations, and where the repository of mix data stores data describing a relationship between a track and a state of an audience, data describing a relationship between a track and a dynamic of an audience, data describing a relationship between a track and a gamification score, data describing a relationship between a sequence of tracks and a state of an audience, data describing a relationship between a sequence of tracks and a dynamic of an audience, or data describing a relationship between a sequence of tracks and certain levels of gamification scores.

4. The apparatus of claim 2, where the state of the audience includes a number of people dancing, a percentage of people dancing, a demographic of people dancing, a number of people sitting, a percentage of people sitting, a demographic of people sitting, a number of people standing alone, a percentage of people standing alone, a demographic of people standing alone, a number of people standing in groups, a percentage of people standing in groups, a demographic of people standing in groups, dance energy, a dance pattern, a number of people dancing individually, a percentage of people dancing individually, a demographic of people dancing individually, a number of people dancing in couples, a percentage of people dancing in couples, a demographic of people dancing in couples, a number of people dancing in a group, a percentage of people dancing in a group, or a demographic of people dancing in a group.

5. The apparatus of claim 2, where the dynamic of the audience includes a change in a number of people dancing, a change in a percentage of people dancing, a change in a demographic of people dancing, a change in a number of people sitting, a change in a percentage of people sitting, a change in a demographic of people sitting, a change in a number of people standing alone, a change in a percentage of people standing alone, a change in a demographic of people standing alone, a change in a number of people standing in groups, a change in a percentage of people standing in groups, a change in a demographic of people standing in groups, a change in a dance energy, a change in a dance pattern, a change in a number of people dancing individually, a change in a percentage of people dancing individually, a change in a demographic of people dancing individually, a change in a number of people dancing in couples, a change in a percentage of people dancing in couples, a change in a demographic of people dancing in couples, a change in a number of people dancing in a group, a change in a percentage of people dancing in a group, a change in a demographic of people dancing in a group, a change in dancing patterns or numbers across demographics of the audience.

6. The apparatus of claim 2, where the plurality of sensors includes two or more of:
a gesture sensor that identifies a first level of audience approval based on one or more gestures from one or more members of the audience, where the one or more gestures include single gestures, collective gestures, appropriate gestures, inappropriate gestures, gestures that indicate approval, or gestures that indicate disapproval;
a sound sensor that identifies a second level of audience approval based on one or more sounds from one or more members of the audience, where the one or more sounds include sounds of approval, sounds of disapproval, singing along, chanting, appropriate participatory interjections, or inappropriate participatory interjections;
a concurrency pattern sensor that identifies a third level of audience approval based on dance patterns in the audience, where the dance patterns include line dancing, conga line dancing, partner dancing, choreographed dancing, individual dancing or a custom dancing pattern;
a facial pattern sensor that identifies a fourth level of audience approval based on one or more facial expressions from one or more members of the audience, where the one or more facial expressions include facial expressions of approval, facial expressions of disapproval, facial expressions of surprise, or facial expressions of excitement, or
a motion pattern detection sensor that identifies a fifth level of audience approval from data submitted by sensors carried by members of the audience.

7. The apparatus of claim 6, where the first logic determines the state of the audience based, at least in part, on at least two members of the group including the first level of audience approval, the second level of audience approval, the third level of audience approval, the fourth level of audience approval, and the fifth level of audience approval.

8. The apparatus of claim 2, where the one or more gamification scores for a particular member of the audience are computed based, at least in part, on how much the particular audience member is dancing, how much the particular audience member is talking, how well the particular audience member is dancing, how energetically the particular audience member is dancing, how elegantly the particular audience member is dancing, how appropriately the particular audience member is dancing, the heterogeneity of the partners with whom the particular audience member is dancing, the heterogeneity of the partners with whom the particular audience member is talking, the popularity of the partners with whom the particular audience member is dancing, or the popularity of the partners with whom the particular audience member is talking.

9. The apparatus of claim 8, where the second logic identifies one or more game leaders or one or more game laggards based, at least in part, on the one or more gamification scores.

10. The apparatus of claim 9, where the second logic provides information about one or more of the game leaders or one or more of the game laggards during the music presentation or after the music presentation.

11. The apparatus of claim 9, where the second logic provides a reward to one or more of the game leaders during or after the music presentation or provides an incentive to one or more of the game laggards during the music presentation.

12. The apparatus of claim 9, where the third logic automatically selectively manipulates the music presentation based on a reaction of one or more of the game leaders to a track, or based on a reaction of one or more of the game laggards to a track.

13. The apparatus of claim 2, where the third logic selectively manipulates the music presentation by changing the amount of time for which a current track will be played, by changing the volume at which the current track will be played, by changing the length of time for which a subsequent track in the mix will be played, by changing the volume at which a subsequent track in the mix will be played, by changing whether a subsequent track in the mix will be played, and by changing an order in which one or more subsequent tracks in the mix will be played, where the current track is the track that impacted the state of the audience, that generated the dynamic of the audience, that impacted the gamification scores for the one or more members of the audience, that generated the reaction of the game leader, or that generated the reaction of the game laggard.

14. The apparatus of claim 2, comprising a fourth logic that receives a request for a requested track from a requestor and establishes a position in the mix for the requested track based, at least in part, on a gamification score associated with the requestor.

15. The apparatus of claim 14, where the fourth logic manipulates the position in the mix for the requested track based, at least in part, on gamification scores concerning the request, where the gamification scores concerning the request are determined from request data retrieved from the plurality of sensors, where the request data is associated with the request being presented to the audience.

16. The apparatus of claim 2, comprising a fifth logic that selectively acquires a photograph, video, or sound recording for a selected audience member at a selected time determined, at least in part, by the state of the audience, the dynamic of the audience, or the gamification score for the selected audience member.

17. The apparatus of claim 16, where the selected time is determined by the gamification score for the selected audience member achieving a threshold value, by the state of the audience achieving a pre-determined state characteristic, or by the dynamic of the audience achieving a pre-determined dynamic characteristic.

18. The apparatus of claim 3, comprising a sixth logic that causes the repository of mix data to be updated with data acquired during the music presentation, where the data acquired during the music presentation includes data describing a relationship between a track and a state of an audience, data describing a relationship between a track and a dynamic of an audience, data describing a relationship between a track and a gamification score, data describing a relationship between a sequence of tracks and a state of an audience, data describing a relationship between a sequence of tracks and a dynamic of an audience, or data describing a relationship between a sequence of tracks and a gamification score.

19. The apparatus of claim 18, where the sixth logic causes the repository of mix data to be updated with data describing a planned mix for the music presentation, an actual mix played during the music presentation, or a correlation between a mix played during the music presentation and a desired trajectory associated with the music presentation.

20. The apparatus of claim 1, where the apparatus is a game console and where at least one of the plurality of sensors are integrated into the game console.

21. The apparatus of claim 1, where the third logic selectively automatically controls a media presentation related to the music presentation based, at least in part, on the state of the audience, on the dynamic of the audience, and on a gamification score for one or more members of the audience.

22. The apparatus of claim 1, where the music presentation includes one or more sample periods and one or more performance periods, and where the third logic does not manipulate the music presentation during the one or more sample periods.

23. The apparatus of claim 1, where the second logic determines a gamification score for the music presentation.

24. The apparatus of claim 23, where the music presentation is ranked with respect to other relevant music presentations based, at least in part, on the gamification score for the music presentation.

25. The apparatus of claim 24, where an event level reward is presented based on the gamification score for the music presentation with respect to other relevant music presentations.

26. The apparatus of claim 1, where the desired trajectory contains information concerning an expected music presentation duration, a scheduled break, a fixed song that cannot be removed from the music presentation, a phase of the music presentation, an expected song arrangement, an expected style arrangement, or a specific goal set.

27. The apparatus of claim 1, where the data acquired during a previous music presentation includes data concerning a date of the presentation, a classification of the music presentation, a language associated with the music presentation, a culture associated with the music presentation, an association with other music presentations, seasonal information, or demographic information.

28. The apparatus of claim 8, where the gamification score for the particular member of the audience is compared to other gamification scores associated with over music presentations.

29. The apparatus of claim 1, where the third logic selectively manipulates the music presentation based, at least in part, on the state of one or more other audiences being monitored by one or more other gamified digital disc jockey apparatus, on the dynamic of one or more other audiences being monitored by one or more other gamified digital disc jockey apparatus, or on one or more gamification scores for one or more members of one or more other audience members being monitored by one or more other gamified digital disc jockey apparatus.

30. A computerized method, comprising: automatically updating a media presentation being presented to an audience in response to a state of the audience and a dynamic of the audience, where the state of the audience and the dynamic of the audience depend, at least in part, on gamification patterns associated with members of the audience.

31. The method of claim 30, where the media presentation is updated to increase a likelihood that a subsequent state of the audience will approach a desired state of the audience at a selected point in time and to increase a likelihood that a subsequent dynamic of the audience will approach a desired dynamic of the audience at the selected point in time.

32. A computer-readable storage device storing computer-executable instructions that when executed by a computer control the computer to perform a method, the method comprising:
controlling the computer to present a media presentation to an audience;
controlling the computer to compute, during the media presentation, a gamification pattern associated with members of the audience during the media presentation;
controlling the computer to compute, during the media presentation, a level of approval of the audience during the media presentation; and
controlling the computer to selectively automatically update the media presentation during the media presentation in response to the gamification pattern and the level of approval of the audience,
where the media presentation is updated to increase a likelihood that a subsequent level of approval of the audience during the media presentation will approach a desired target level,
where the media presentation is updated by changing the amount of time for which an element of the media presentation will be presented, by changing the volume at which an element of the media presentation will be presented, and by changing the order in which one or more elements of the media presentation will be presented,
where the gamification pattern and the level of audience approval are determined from:
data provided by a gesture sensor that identifies one or more gestures from one or more members of the audience,
data provided by a sound sensor that identifies one or more sounds from one or more members of the audience,
data provided by a concurrency pattern sensor that identifies one or more movement patterns in the audience,
data provided by a facial pattern sensor that identifies one or more facial expressions from one or more members of the audience, and
data associated with a media presentation made at a previous time.
